(19) United States
(12) Patent Application Publication
(10) Pub. No.: US 2008/0252584 A1
(43) Pub. Date: Oct. 16, 2008

(54) LIQUID CRYSTAL DISPLAY DEVICE

(75) Inventors: Toshio Maeda, Chiba (JP); Toshiki Misonou, Ichihara (JP); Tomohide Oohira, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/099,201

(22) Filed: Apr. 8, 2008

(30) Foreign Application Priority Data
Apr. 10, 2007 (JP) 2007-102881

(51) Int. Cl. G09G 3/36

(52) U.S. Cl. 345/94

(57) ABSTRACT

In a liquid crystal display panel including a plurality of scanning lines, a scanning line drive circuit which supplies a scanning voltage to the plurality of scanning lines, and a counter voltage supply circuit which supplies a counter voltage to a counter electrode of each pixel, the counter voltage supply circuit supplies a voltage which is obtained by multiplying a voltage detected from the counter electrode by correction coefficients corresponding to the plurality of respective scanning lines to the counter electrodes. The present invention provides a liquid crystal panel which can perform favorable display by preventing crosstalk attributed to coupling noises to the counter electrodes generated by AC driving of a video voltage.

### CROSS-REFERENCE TO RELATED APPLICATION

The present application claims priority from Japanese application JP2007-102881 filed on Apr. 10, 2007, the content of which is hereby incorporated by reference into this application

### BACKGROUND OF THE INVENTION

1. Field of the Invention

The present invention relates to a liquid crystal display device, and more particularly to a liquid crystal display device which corrects the voltage fluctuation of a counter electrode of a large-sized high-definition liquid crystal display panel.

2. Description of the Related Art

Recently, a liquid crystal display module has been popularly used as a display device ranging from a small-sized display device to a large-sized display device such as office automation equipment or a large-sized television receiver set. In such a liquid crystal display module, a liquid crystal display panel (also referred to as a liquid crystal display element or a liquid crystal cell) is configured such that a liquid crystal composition layer (a liquid crystal layer) is sandwiched between a pair of insulation substrates, and at least either one of the pair of insulation substrates is formed of a transparent glass substrate, a plastic substrate or the like basically.

Particularly, a TFT-type liquid crystal display module using thin film transistors as active elements can display a high-definition image and hence, such a liquid crystal display module is used as a display device of a television receiver set, a personal computer display or the like.

In general, an active-matrix-type liquid crystal display device adopts a vertical electric field method which applies an electric field for changing the alignment direction of the liquid crystal layer between electrodes formed on one substrate and electrodes formed on another substrate. Further, a transverse-electric-field-type (also referred to as an IPS (In-Plane Switching)-type) liquid crystal display module which arranges the direction of an electric field applied to the liquid crystal layer substantially parallel to a surface of the substrate has been put into practice.

With respect to such a liquid crystal display panel, in a region surrounded by two neighboring scanning lines (also referred to as gate lines) and two neighboring video lines (also referred to as source lines or drain lines), a thin film transistor which is turned on when a selective scanning signal is inputted thereto from a scanning line and a pixel electrode to which a video signal is supplied from a video line via the thin film transistor are formed thus constituting a so-called sub pixel.

Further, a video voltage (a grayscale voltage) is supplied to the plurality of video lines from a drain driver arranged on a peripheral portion of the liquid crystal display panel, and a selective scanning voltage is supplied to the plurality of scanning lines from a gate driver arranged on a peripheral portion of the liquid crystal display panel.

When a DC voltage (DC) is applied to the liquid crystal for a long time, a lifetime of the liquid crystal is shortened and hence, so-called AC-driving which changes the video voltage inputted to the pixel electrode of each sub pixel to a potential higher than the counter voltage applied to the counter electrode or a potential lower than the counter voltage applied to the counter electrode at a fixed cycle is generally performed.

In the active-matrix-type liquid crystal display module, the absolute number of the video lines is increased along with the elevation of the definition of the liquid crystal display panel and hence, when the video line voltage fluctuates in the AC-driving, coupling noises which affect the counter electrode are increased.

Further, along with the large-sizing of the liquid crystal display panel, a resistance component from a counter voltage supply source which supplies the counter voltage to the counter electrode cannot be ignored thus giving rise to a drawback that the difference in coupling noises attributed to the fluctuation of the video line becomes large between a near end of the counter electrode and a remote end of the counter electrode from the counter voltage supply source.

To overcome this drawback, as a prior-art document relating to the present invention, there has been proposed a technique which supplies an inverting signal indicative of the voltage fluctuation of a counter electrode detected at a specified portion to the counter electrode (see, JP-A-6-186530 (patent document 1)).

### SUMMARY OF THE INVENTION

However, as described in the above-mentioned patent document 1, the technique which merely supplies the inverting signal indicative of the voltage fluctuation of the counter electrode detected at the specified portion generates irregularities dependent on distances from the counter voltage supply source on the liquid crystal display panel. The technique also causes the deterioration of image quality attributed to crosstalk or the like.

The present invention has been made to overcome the above-mentioned drawback of the related art, and it is an object of the present invention to provide a liquid crystal display device which can prevent, in a liquid crystal display panel, crosstalk attributed to coupling noises generated by AC driving of a video voltage which affect a counter electrode thus preventing the deterioration of display quality of a display image of the liquid crystal display panel.

The above-mentioned and other objects and novel features of the present invention will become apparent from the description of this specification and attached drawings.

To briefly explain the summary of typical inventions among the inventions disclosed in this specification, they are as follows.

(1) In a liquid crystal display device which includes: a liquid crystal display panel including a plurality of sub pixels and a plurality of scanning lines which inputs a selective scanning voltage to the plurality of sub pixels; and a scanning line drive circuit which sequentially supplies the selective scanning voltage to the plurality of scanning lines, each sub pixel of the plurality of sub pixels includes a counter electrode, the liquid crystal display device includes a counter voltage supply circuit which supplies a counter voltage to the counter electrode, a correction coefficient is set corresponding to each one of the plurality of scanning lines, and the counter voltage supply circuit supplies a voltage which is obtained by multiplying a voltage detected from a specified portion of the counter electrode of the liquid crystal display panel by the correction coefficient corresponding to the scanning line to which the scanning line drive circuit supplies the selective scanning voltage to the counter electrode.

(2) In the above-mentioned constitution (1), the correction coefficient is set for every scanning line of the plurality of scanning lines.

(3) In the above-mentioned constitution (1), the plurality of scanning lines is divided into a plurality of groups, and the correction coefficient is set for every group of the scanning lines.

(4) In a liquid crystal display device including: a liquid crystal display panel including a plurality of sub pixels and a plurality of scanning lines which inputs a selective scanning voltage to the plurality of sub pixels; and a scanning line drive circuit which sequentially supplies the selective scanning voltage to the plurality of scanning lines, each sub pixel of the plurality of sub pixels includes a counter electrode, the liquid crystal display device includes a counter voltage supply circuit which supplies a counter voltage to the counter electrode, the counter voltage supply circuit includes an inverting amplifier which inversely amplifies a voltage detected at a specified portion of the counter electrode of the liquid crystal display panel, the counter voltage supply circuit supplies the voltage inversely amplified by the inverting amplifier to a counter voltage supply end of the counter electrode, and the inverting amplifier changes a gain corresponding to a position of the scanning line to which the scanning line drive circuit supplies a selective scanning voltage.

(5) In the above-mentioned constitution (4), the larger a distance between the counter voltage supply end and each one of the plurality of scanning lines, the larger the gain becomes.

(6) In the above-mentioned constitution (4) or (5), the gain is changed for every scanning line of the plurality of scanning lines.

(7) In the above-mentioned constitution (4) or (5), the plurality of scanning lines is divided into a plurality of groups, and the gain is changed for every group of the scanning lines.

(8) In any one of the above-mentioned constitutions (4) to (7), the inverting amplifier is constituted of an operational amplifier which is formed by connecting a feedback resistance between an inverting input terminal and an output terminal thereof, and a resistance value of the feedback resistance is changed corresponding to a position of the scanning line to which the scanning line drive circuit supplies the selective scanning voltage.

(9) In the above-mentioned constitution (8), the feedback resistance is a digital potentiometer.

(10) In any one of the above-mentioned constitutions (1) to (9), the liquid crystal display panel includes a plurality of video lines which inputs a video voltage to the plurality of sub pixels, the liquid crystal display device includes a video line drive circuit which supplies the video voltage to the plurality of video lines, the counter voltage supply end of the counter electrode is an end portion of the counter electrode on a side close to the video line drive circuit, and the specified portion of the liquid crystal display panel is an end portion of the counter electrode on a side remotest from the video line drive circuit.

To briefly explain advantageous effects acquired by the present inventions disclosed in this specification, they are as follows.

According to the present invention, in a large-sized high-definition liquid crystal display panel, it is possible to prevent crosstalk attributed to coupling noises generated by AC driving of a video voltage which affect a counter electrode thus preventing the deterioration of display quality of a display image of the liquid crystal display panel.

### BRIEF DESCRIPTION OF THE DRAWINGS

FIG. 1 is a view showing the schematic constitution of a liquid crystal display module according to one embodiment of the present invention;

FIG. 2 is a circuit diagram showing an equivalent circuit of a liquid crystal display panel 1 shown in FIG. 1;

FIG. 3 is a view for explaining capaciatances in one sub pixel;

FIG. 4 is a schematic view for explaining a state in which a counter electrode is influenced by parasitic capacitances by coupling corresponding to the voltage fluctuation of video lines;

FIG. 5 is a view showing a counter voltage correction circuit of the counter electrode described in patent document 1;

FIG. 6 is a view showing a comparison between the voltage fluctuation correction of the counter electrode performed by the counter voltage correction circuit described in patent document 1 and the voltage fluctuation correction of the counter electrode performed by the counter voltage correction circuit of this embodiment;

FIG. 7 is a circuit diagram showing one example of an inverting amplifier of the embodiment of the present invention; and

FIG. 8 is a view showing a display pattern which is liable to generate crosstalk.

### DESCRIPTION OF THE PREFERRED EMBODIMENT

Hereinafter, an embodiment of the present invention is explained in detail in conjunction with drawings.

Here, in all drawings for explaining the embodiment, parts having identical functions are given same numerals and their repeated explanation is omitted.

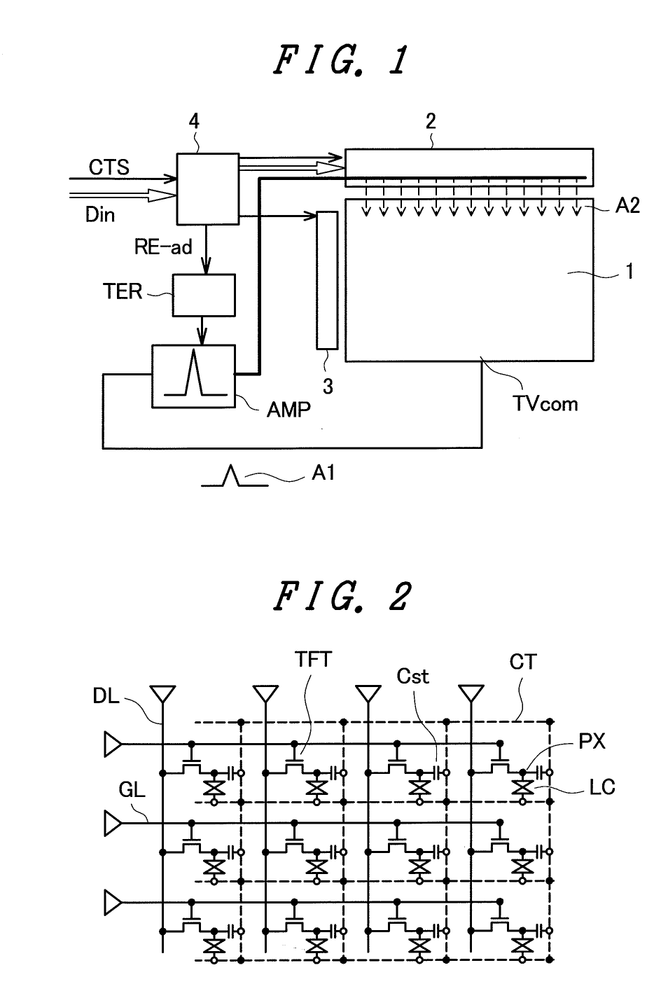

FIG. 1 shows the schematic constitution of a liquid crystal display module according to one embodiment of the present invention, and FIG. 2 is a circuit diagram showing an equivalent circuit of a liquid crystal display panel 1 shown in FIG. 1.

The liquid crystal display module of this embodiment is constituted of the liquid crystal display panel 1, a drain driver 2, a gate driver 3, a display control circuit 4 and a power source circuit (not shown in the drawing).

The liquid crystal display module of this embodiment includes a counter voltage detection terminal (TVcom), an inverting amplifier (AMP), and a coefficient table (TER) which constitute a pixel-position-corresponding counter voltage correction circuit.

The drain driver 2 and the gate driver 3 are mounted on peripheral portions of the display panel 1. For example, the drain driver 2 and the gate driver 3 are respectively mounted on peripheral portions on two sides of a first substrate (for example, formed of a glass substrate) out of a pair of substrates of the liquid crystal display panel 1 by a COG method. Alternatively, the drain driver 2 and the gate driver 3 are respectively mounted on flexible printed circuit boards arranged on the peripheral portions on two sides of the first substrate of the liquid crystal display panel 1 by a COF method.

Further, the display control circuit 4 and the power source circuit are respectively mounted on a printed circuit board arranged on a peripheral portion of the liquid crystal display panel 1 (for example, a back side of the liquid crystal display module). The power source circuit generates various voltages necessary for operating the liquid crystal display device.

The display control circuit 4 converts display control signals (CTS) and display data (Din) inputted from a display signal source (a host computer side) of a personal computer, a television receiver circuit or the like into display data having a display format by performing the timing adjustment suitable for the liquid crystal display panel 1 such as the formation of AC data and inputs the converted data into the drain driver 2 and the gate driver 3 together with a synchronizing signal (a clock signal).

The gate driver 3 sequentially supplies a selective scanning voltage to scanning lines (also referred to as gate lines: GL) based on a control by the display control circuit 4, while the drain driver 2 displays an image by supplying a video voltage to video lines (also referred to as drain lines or source lines: DL).

As shown in FIG. 2, the liquid crystal display panel 1 includes a plurality of sub pixels, and each sub pixel is formed in a region surrounded by the video lines (DL) and the scanning lines (GL).

Each sub pixel includes a thin film transistor (TFT). A first electrode (a drain electrode or a source electrode) of the thin film transistor (TFT) is connected to the video line (DL), while a second electrode (a source electrode or a drain electrode) of the thin film transistor (TFT) is connected to a pixel electrode (PX). Further, a gate electrode of the thin film transistor (TFT) is connected to the scanning line (GL).

In FIG. 2, symbol LC indicates a liquid crystal capacitance equivalently indicating a liquid crystal layer arranged between the pixel electrode (PX) and a counter electrode (CT), and symbol Cst indicates a holding capacitance formed between the pixel electrode (PX) and the counter electrode (CT).

In the liquid crystal display panel 1 shown in FIG. 1, the first electrodes of the thin film transistors (TFT) of the respective sub pixels arranged in the column direction are respectively connected to the video line (DL), while the respective video lines (DL) are connected to the drain driver 2 which supplies a video voltage (a grayscale voltage) corresponding to the display data to the sub pixels arranged in the column direction.

Further, the gate electrodes of the thin film transistors (TFT) of the respective sub pixels arranged in the row direction are respectively connected to the scanning line (GL), and the respective scanning lines (GL) are connected to the gate driver 3 which supplies the scanning voltage (positive or negative bias voltage) to the gates of the thin film transistors (TFT) for 1 horizontal scanning time.

The display control circuit 4 is constituted of one semiconductor integrated circuit (LSI), and controls and drives the drain driver 2 and the gate driver 3 based on respective display control signals consisting of a dot clock (DCLK) inputted from the outside, a display timing signal (DTMG), an external horizontal synchronizing signal (HSYNC), and an external vertical synchronizing signal (VSYNC) and display-use data.

The display control circuit 4, when the display timing signal (DTMG) is inputted, determines the display timing signal (DTMG) as a signal indicative of a display start position, and outputs received simple one line of display data to the drain driver 2 via a bus line of the display data.

Here, the display control circuit 4 outputs a display-data-latch clock signal (CL2) which is a display control signal for latching display data to a data latch circuit of the drain driver 2 via a signal line.

The display control circuit 4, when inputting of the display timing signal (DTMG) is finished or a predetermined fixed time elapses after inputting of the display timing signal (DTMG), assumes that display data amounting to 1 horizontal line is finished, and outputs an output-timing-control clock signal (CL1) which is a display control signal for outputting the display data stored in the latch circuit of the drain driver 2 to the video lines (DL) of the liquid crystal display panel 1 to the drain driver 2 via a signal line. Due to such an operation, the drain driver 2 supplies a video voltage corresponding to the display data to the video lines (DL).

Further, the display control circuit 4, when the first display timing signal is inputted after inputting the vertical synchronizing signal, determines the first display timing signal as a signal indicative of the first display line, and outputs a frame start command signal (FLM) to the gate driver 3 by way of a signal line.

Further, the display control circuit 4 outputs a shift clock (CL3) of 1 horizontal scanning time cycle to the gate driver 3 by way of a signal line such that the display control circuit 4 sequentially supplies a selective scanning voltage (positive bias voltage) to the respective scanning lines (GL) of the liquid crystal display panel 1 for every 1 horizontal scanning time based on the horizontal synchronizing signal.

Due to such an operation, the plurality of thin film transistors (TFT) connected to each scanning line (GL) of the liquid crystal display panel 1 becomes conductive for 1 horizontal scanning time.

The voltage supplied to the video line (DL) is applied to the pixel electrodes (PX) via the thin film transistors (TFT) which are conductive for 1 horizontal scanning time, and eventually a charge is applied to the holding capacitance (Cst) and the liquid crystal capacitance (LC) and hence, liquid crystal molecules are controlled to perform image display.

The liquid crystal display panel 1 is configured such that a first substrate which forms the pixel electrodes (PX), the thin film transistors (TFT) and the like thereon and a second substrate which forms color filters and the like thereon overlap with each other with a predetermined gap therebetween, and both substrates are adhered to each other using a sealing material formed in a frame shape in the vicinity of a peripheral portion between both substrates, liquid crystal is filled and sealed in the inside of the sealing material between both substrates from a liquid crystal filling port formed in a portion of the sealing material, and a polarizer is laminated to outer surfaces of both substrates.

Here, the counter electrode (CT) is mounted on the second substrate side when a TN-method or VA-method liquid crystal display panel is adopted, while the counter electrode (CT) is mounted on the first substrate side when an IPS-method liquid crystal display panel is adopted.

Further, the present invention is irrelevant to the inner structure of the liquid crystal panel and hence, the detailed explanation of the inner structure of the liquid crystal panel is omitted. Further, the present invention is applicable to a liquid crystal panel of any structure.

The counter electrodes (CT) are connected with each other such that the counter electrodes (CT) have the same potential over the whole liquid crystal display panel, and a voltage from an inverting amplifier (AMP) is supplied to the counter electrodes (CT) of the liquid crystal display panel via a drain driver printed circuit board as indicated by A2 in FIG. 1.

In this embodiment, to correct the fluctuation of the counter electrode (CT) attributed to the voltage fluctuation of the video line (DL), a counter voltage detection terminal (TVcom) is provided at an end of the counter electrode (CT) remotest from a counter voltage supply point, and a voltage (indicated by A1 in FIG. 1) detected by the counter voltage detection terminal (TVcom) is inputted into the inverting amplifier (AMP).

The inverting amplifier (AMP) is constituted of an inverting amplifier using an operational amplifier, for example, as described later. An amplifying gain is set to a correction coefficient read from a coefficient table (TER) with a read address (RE-ad) corresponding to a display line position inputted from the display control circuit 4. The coefficient which determines the gain is sequentially changed.

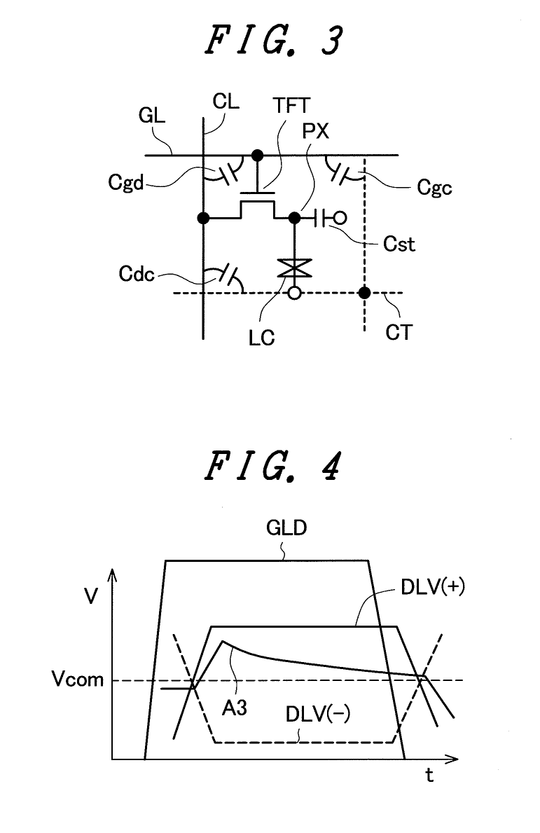

FIG. 3 is a view for explaining portions forming capacitances in one sub pixel. In FIG. 3, symbol LC indicates a liquid crystal capacitance of the sub pixel, symbol Cdc indicates a parasitic capacitance between the video line and the counter electrode, symbol Cgc indicates a parasitic capacitance between the scanning line and the counter electrode, and symbol Cgd indicates a parasitic capacitance between the scanning line and the video line.

FIG. 4 is a schematic view for explaining a state in which the counter electrode (CT) is influenced by the parasitic capacitances by coupling corresponding to the voltage fluctuation of the video line (DL).

To reduce flickers on a screen of the liquid crystal display panel 1, in general, voltages of two neighboring video lines (DL) are set to be driven with polarities opposite to each other. In FIG. 4, symbol DLV(+) indicates a positive video voltage of the video line (DL), symbol DLV(−) indicates negative video voltage of the video line (DL), and symbol GLV indicates a selective scanning voltage of the scanning line (GL).

As described previously, the video voltage inputted to the video line (DL) has the polarity thereof inverted with respect to the counter voltage (Vcom) of the counter electrode (CT) at a fixed cycle for preventing the application of a direct current (DC) to the liquid crystal.

However, when a specified pattern is displayed, with respect to the video voltage inputted to the video line (DL), the video voltage of one polarity becomes larger than the video voltage of another polarity and hence, as indicted by A3 in FIG. 4, the voltage of the counter electrode (CT) is fluctuated due to coupling of the parasitic capacitance.

Thereafter, when the counter voltage (Vcom) is supplied to the counter electrode from the counter voltage supply circuit (inverting amplifier (AMP) in this embodiment), the voltage of the counter electrode (CT) returns to the original counter voltage (Vcom). However, when the voltage of the counter electrode (CT) cannot return to the original counter voltage (Vcom) before the scanning line (GL) assumes an OFF state, a voltage which differs from the voltage to be written originally is written in the pixel capacitance (LC) thus leading to erroneous writing whereby display quality is deteriorated.

In a relatively small-sized liquid crystal display panel, an area of the counter electrode (CT) is small and hence, even when the voltage of the counter electrode (CT) is fluctuated, the voltage of the counter electrode easily restores the original potential whereby the deterioration of the display quality is small. However, in a high definition panel, the number of video lines (DL) is increased and hence, the influence of the parasitic capacitance (Cgc) between the scanning line and the counter electrode via the parasitic capacitance (Cdc) between the video line and the counter electrode and the parasitic capacitance (Cgd) between the scanning line and the video line is increased.

Further, recently, with respect to a frame refresh rate of the liquid crystal display panel 1, to cope with an animated image, twofold-speed driving or threefold-speed driving is performed so that an ON time of a gate is steadily becoming shorter. Accordingly, a time that the counter electrode (CT) with the fluctuated voltage restored to the original counter voltage (Vcom) cannot be ensured sufficiently leading to the generation of erroneous writing and hence, deterioration of image quality such as crosstalk becomes conspicuous.

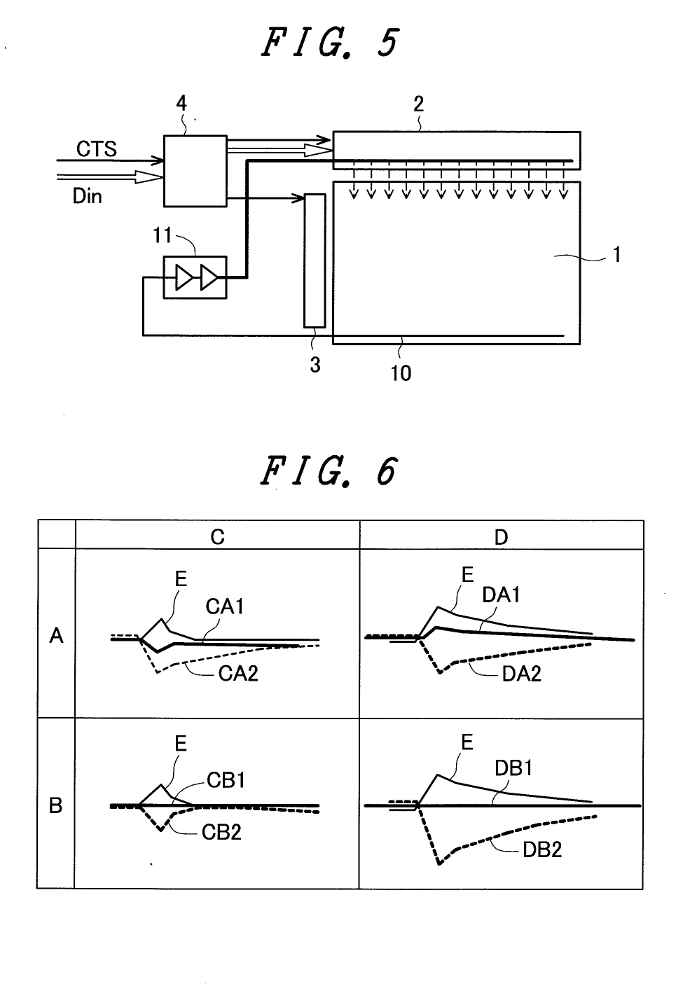

FIG. 5 shows the counter voltage correction circuit of the counter electrode (CT) described in patent document 1.

In the counter voltage correction circuit of the counter electrode (CT) described in the above-mentioned patent document 1, the voltage fluctuation of the counter electrode (CT) detected by a sensing line 10 is inputted to an inverting circuit 11, and an inverted signal is supplied to the counter electrode (CT).

FIG. 6 compares the voltage fluctuation correction of the counter electrode (CT) by the counter voltage correction circuit described in patent document 1 and the voltage fluctuation correction of the counter electrode (CT) by the counter voltage correction circuit of this embodiment.

In FIG. 6, symbol A indicates the voltage fluctuation correction of the counter electrode (CT) by the counter voltage correction circuit described in patent document 1, and symbol B indicates the voltage fluctuation correction of the counter electrode (CT) by the counter voltage correction circuit of this embodiment. Further, symbol C indicates the voltage fluctuation correction when the counter voltage detection terminal is close to the counter voltage supply end, and symbol D indicates the voltage fluctuation correction when the counter voltage detection terminal is remote from the counter voltage supply end.

In the liquid crystal display device described in the above-mentioned patent document 1, the supply of the counter voltage to the counter electrode (CT) of the liquid crystal display panel is improved such that the supply line is arranged along an outermost periphery of the liquid crystal display panel. However, the liquid crystal display panel per se becomes large-sized and hence, the resistance component in the liquid crystal display panel cannot be ignored whereby the difference in time constant at the time of supplying the counter voltage is enlarged between a portion of the liquid crystal display panel close to the counter voltage supply end and a portion of the liquid crystal display panel remote from the counter voltage supply end. Accordingly, for example, when a voltage (indicated by E in FIG. 6) of the counter electrode (CT) at a position remotest from the counter voltage supply end of the liquid crystal display panel is detected and the correction (indicated by CA2 and DA2 in FIG. 6) is made, the excessive correction (indicated by CA1 in FIG. 6) is made on a side of the liquid crystal display panel close to the counter voltage supply end, while the insufficient correction (indicated by DA1 in FIG. 6) is made in the liquid crystal display panel on a remote end side due to the resistance component in the liquid crystal display panel.

On the other hand, in the case of the counter voltage correction circuit of this embodiment, a coefficient which takes the resistance component in the liquid crystal display panel into consideration is preliminarily set based on the distance between the scanning line (GL) during scanning and the counter voltage supply end, and a voltage obtained by multiplying the detected voltage (indicated by E in FIG. 6) by the coefficient (indicated by CB2, DB2 in FIG. 6) is supplied to the counter electrode (CT) in an interlocking manner with the display line position and hence, the uniform correction (indicated by CB1, DB1 in FIG. 6) can be performed in the liquid crystal display panel.

A specific example of this embodiment is explained hereinafter.

As shown in FIG. 1, the counter voltage (Vcom) is generated in a peripheral circuit, and the counter voltage (Vcom) is supplied to the counter electrode (CT) of the liquid crystal display panel 1 via the video line drive printed circuit board of low resistance. In the example shown in FIG. 1, an upper portion of the liquid crystal display panel forms a side close to the counter voltage supply end, and a lower portion of the liquid crystal display panel forms a remote end side of the counter voltage supply end.

The counter electrode (CT) is influenced by AC driving of the video lines (DL) via the pixel capacitances (LC) and the respective parasitic capacitances (Cdc, Cgc, Cgd). A quantity of influence is determined based on the difference in fluctuation quantity toward positive polarity or negative polarity of the video line (DL) on one display line.

FIG. 8 shows a display pattern which is liable to generate crosstalk. In general, one pixel of a panel of a liquid crystal display module is constituted of a set of sub pixels of three primary colors consisting of R, G, B, and the sub pixels of R, G, B are arranged in a sequentially repeated manner. To each one of these sub pixels of R, G, B, the video line (DL) and the pixel capacitance (LC) are connected, and a video voltage which is image information is supplied to each sub pixel from the drain driver 2.

As described previously, in general, to reduce flickers on the screen of the liquid crystal display panel, the video voltages supplied to the neighboring video lines (DL) are set to have the polarities opposite to each other. For example, in the case of a normally-black liquid crystal display module, when white display is performed, a maximum video voltage of positive polarity (POT) is applied to the sub pixels of R and B, and a maximum video voltage of negative polarity (NEG) is applied to the sub pixels of G. When the application of these video voltages is repeated, that is, the white and black are alternately displayed per pixel unit in one line, the video line (DL) of G to which the video voltage of negative polarity is supplied is one half of the video lines (DL) of R, B to which the video voltage of positive polarity is supplied and hence, due to coupling generated by the voltage fluctuation of the video lines (DL), the voltage of the counter electrode (CT) is shifted to the positive-polarity side as indicted by A in FIG. 8.

When the scanning line (GL) is turned off, that is, when writing of the voltage to the pixel capacitance (LC) is finished in such a state, the relatively high voltage is written in only the sub pixel of G with respect to the supplied video voltage and hence, white is shifted to green. Further, in a region which displays an intermediate grayscale (MRA) on the same display line, contrast is generated per one pixel unit and hence, an image-quality deterioration phenomenon referred to as crosstalk is observed.

To reduce the deterioration of image quality attributed to the above-mentioned fluctuation of the counter voltage, in this embodiment, the correction voltage corresponding to the display line position of the liquid crystal display panel is applied to the counter electrode (CT) using the pixel-position-corresponding counter voltage correction circuit.

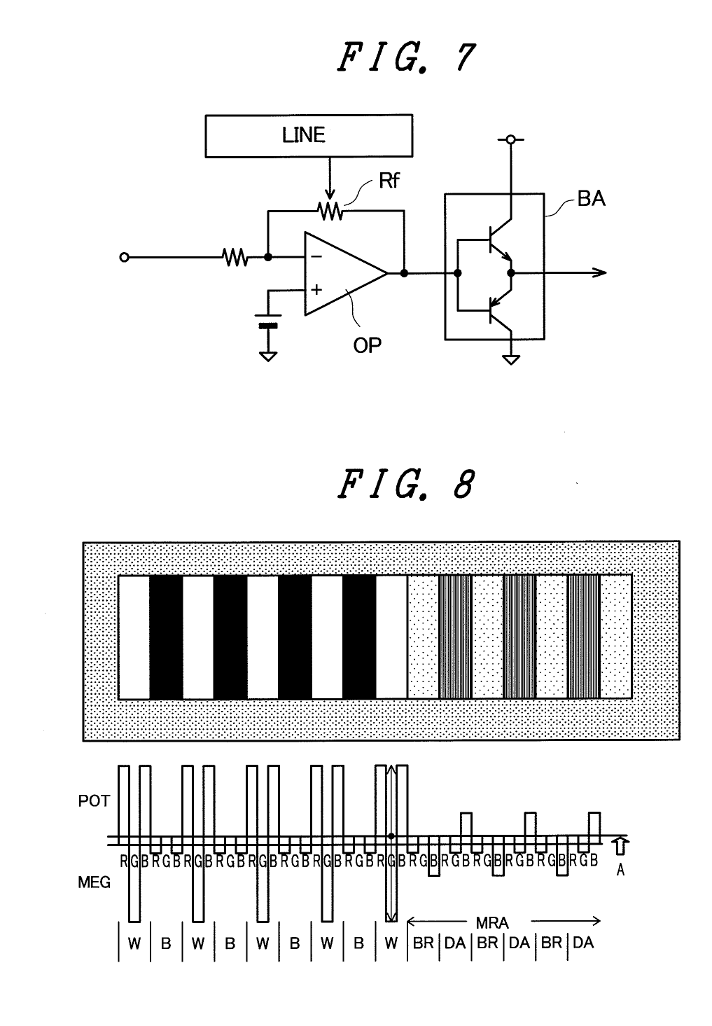

FIG. 7 is a circuit diagram showing one example of the inverting amplifier of this embodiment. FIG. 7 shows an inverting amplifier which uses an operational amplifier (OP). A buffer circuit (BA) constituted of a bipolar transistor is connected to an output terminal of the operational amplifier (OP). Further, a feedback resistance (Rf) is connected between an inverted input terminal (−) and an output terminal of the operational amplifier (OP).

The inverting amplifier shown in FIG. 7 inversely amplifies the voltage from the counter electrode voltage detection terminal (TVcom) on the lower portion of the liquid crystal display panel arranged remotest from the counter voltage supply end of the liquid crystal display panel 1, and supplies the amplified voltage as the counter voltage (Vcom).

In this case, when the scanning line (GL) on the upper portion of the liquid crystal display panel arranged in the vicinity of the counter voltage supply end is scanned, a gain of the inverting amplifier is lowered to prevent the excessive correction, while when the scanning line (GL) on the lower portion of the liquid crystal display panel arranged remote from the counter voltage supply end is scanned, the gain is increased by taking the resistance component in the liquid crystal display panel into consideration thus compensating for the shortage of correction.

As a method which changes a gain of the inverting amplifier corresponding to such scanning, as shown in FIG. 7, the inverting amplifier may be configured such that the feedback resistance (Rf) of the inverting amplifier which uses the operational amplifier (OP) is formed of a variable resistor, and a resistance value of the variable resistor is sequentially changed corresponding to the display line position (LINE). In this case, the resistance value of the variable resistor may be changed for every 1 display line or may be changed for every group unit (for example, every 4 lines).

Further, the variable resistor may be constituted of a digital potentiometer or the like. In this case, in place of the display line position (LINE), a resistance value of the digital potentiometer may be changed in response to a digital value corresponding to the display line position (LINE). Also in this case, the resistance value of the digital potentiometer may be changed for every 1 display line or may be changed for every group unit (for example, for every 4 lines).

Further, it is needless to say that any other circuit method is applicable to this embodiment provided that the method can change the gain corresponding to the display line position from the display control circuit 4.

As has been explained heretofore, according to this embodiment, in the liquid crystal display panel (particularly, the large-sized high-definition liquid crystal display panel), by correcting the fluctuation of the counter voltage (Vcom) attributed to AC driving of the video lines (DL) with the coefficient corresponding to the distance from the counter voltage supply end, the deterioration of the image quality attributed to insufficient writing caused by coupling noises to the counter electrode (CT) generated by AC driving of the video lines (DL) or the deterioration of the image quality attributed to a crosstalk phenomenon over the whole surface of the liquid crystal display panel can be eliminated.

Although the invention made by inventors of the present invention has been specifically explained in conjunction with the embodiment heretofore, the present invention is not limited to the above-mentioned embodiment and various modifications are conceivable without departing from the gist of the present invention.

What is claimed is:

1. A liquid crystal display device comprising:
a liquid crystal display panel including a plurality of sub pixels and a plurality of scanning lines which inputs a selective scanning voltage to the plurality of sub pixels; and
a scanning line drive circuit which sequentially supplies the selective scanning voltage to the plurality of scanning lines, wherein
each sub pixel of the plurality of sub pixels includes a counter electrode,
the liquid crystal display device includes a counter voltage supply circuit which supplies a counter voltage to the counter electrode,
a correction coefficient is set corresponding to each one of the plurality of scanning lines, and
the counter voltage supply circuit supplies a voltage which is obtained by multiplying a voltage detected from a specified portion of the counter electrode of the liquid crystal display panel by the correction coefficient corresponding to the scanning line to which the scanning line drive circuit supplies the selective scanning voltage to the counter electrode.

2. A liquid crystal display device according to claim 1, wherein the correction coefficient is set for every scanning line of the plurality of scanning lines.

3. A liquid crystal display device according to claim 1, wherein the plurality of scanning lines is divided into a plurality of groups, and the correction coefficient is set for every group of the scanning lines.

4. A liquid crystal display device comprising:
a liquid crystal display panel including a plurality of sub pixels and a plurality of scanning lines which inputs a selective scanning voltage to the plurality of sub pixels; and
a scanning line drive circuit which sequentially supplies the selective scanning voltage to the plurality of scanning lines, wherein
each sub pixel of the plurality of sub pixels includes a counter electrode,
the liquid crystal display device includes a counter voltage supply circuit which supplies a counter voltage to the counter electrode,
the counter voltage supply circuit includes an inverting amplifier which inversely amplifies a voltage detected from a specified portion of the counter electrode of the liquid crystal display panel,
the counter voltage supply circuit supplies the voltage inversely amplified by the inverting amplifier to a counter voltage supply end of the counter electrode, and
the inverting amplifier changes a gain corresponding to a position of the scanning line to which the scanning line drive circuit supplies a selective scanning voltage.

5. A liquid crystal display device according to claim 4, wherein the larger a distance between the counter voltage supply end and each one of the plurality of scanning lines, the larger the gain becomes.

6. A liquid crystal display device according to claim 4, wherein the gain is changed for every scanning line of the plurality of scanning lines.

7. A liquid crystal display device according to claim 4, wherein the plurality of scanning lines is divided into a plurality of groups, and the gain is changed for every group of the scanning lines.

8. A liquid crystal display device according to claim 4, wherein the inverting amplifier is constituted of an operational amplifier which is formed by connecting a feedback resistance between an inverting input terminal and an output terminal thereof, and
a resistance value of the feedback resistance is changed corresponding to a position of the scanning line to which the scanning drive circuit supplies the selective scanning voltage.

9. A liquid crystal display device according to claim 8, wherein the feedback resistance is a digital potentiometer.

10. A liquid crystal display device according to claim 1, wherein the liquid crystal display panel includes a plurality of video lines which inputs a video voltage to the plurality of sub pixels,
the liquid crystal display device includes a video line drive circuit which supplies the video voltage to the plurality of video lines,
the counter voltage supply end of the counter electrode is an end portion of the counter electrode on a side close to the video line drive circuit, and
the specified portion of the liquid crystal display panel is an end portion of the counter electrode on a side remotest from the video line drive circuit.

11. A liquid crystal display device according to claim 4, wherein the liquid crystal display panel includes a plurality of video lines which inputs a video voltage to the plurality of sub pixels,
the liquid crystal display device includes a video line drive circuit which supplies the video voltage to the plurality of video lines,
the counter voltage supply end of the counter electrode is an end portion of the counter electrode on a side close to the video line drive circuit, and
the specified portion of the liquid crystal display panel is an end portion of the counter electrode on a side remotest from the video line drive circuit.
